(19) United States
(12) Patent Application Publication
(10) Pub. No.: US 2023/0313521 A1
(43) Pub. Date: Oct. 5, 2023

(54) METHOD FOR CONSTRUCTING PARKING STRUCTURES

(71) Applicant: Newton Group Ltd., Guelph (CA)

(72) Inventors: Paul M. AUMULLER, Guelph (CA); Edwin NEWTON, Guelph (CA)

(21) Appl. No.: 18/128,686

(22) Filed: Mar. 30, 2023

Related U.S. Application Data
(60) Provisional application No. 63/325,306, filed on Mar. 30, 2022.

(51) Int. Cl. E04B 1/24

(52) U.S. Cl. CPC E04B 1/24; E04B 2001/2481; E04B 2001/2484; B28B 1/14

(57) ABSTRACT

The method is for constructing parking structures, each parking structure having a site and being of the type including a plurality of parking decks, each deck being defined by a plurality of steel beams supporting a plurality of cementitious panels. The method is of the type wherein each panel is manufactured by pouring concrete into a form remote from the site. The improvement comprises: transporting a plurality of forms to premises proximal to the site; and constructing the panels.

### FIELD OF THE INVENTION

The invention relates to the construction of parking structures.

### BACKGROUND

A method for producing parking structures is taught in U.S. Ser. No. 12/870,240.

### SUMMARY OF THE INVENTION

Forming an aspect of the invention is an improved method for constructing parking structures.

Each structure has a site and is of the type including a plurality of parking decks, each deck being defined by a plurality of steel beams supporting a plurality of cementitious panels.

In the method, each panel is manufactured by pouring concrete into a form remote from the site.

The improvement comprises: transporting a plurality of forms to premises proximal to the site; and constructing the panels.

According to another aspect, the concrete can be: mixed remote from the premises and shipped to the premises in a ready-mix truck; or shipped to the premises in a mixer truck.

According to another aspect, the concrete can be delivered to a crane-supported bucket at the premises and delivered thereby to the form.

According to another aspect, the concrete poured into a form can be hardened to form a green panel and the green panel can be transformed by subsequent curing into a panel.

According to another aspect, curing of green panels can be carried out externally of the forms.

According to another aspect, removal of a green panel from a form can involve tilting the form and the green panel 90° by a tilt table.

According to another aspect, the panels can be cured at the premises in a comb.

According to another aspect, the green panel, once tilted by the tilt table, can be moved by a crane to the comb.

According to another aspect, the comb can be transported to the premises.

According to another aspect, the tilt table can be transported to the premises.

According to another aspect, parking structures can be completed in seriatim and, once the panels of a structure in the series have been completed, the forms and tilt table are transported to the next structure in the series to be completed.

According to another aspect, the granular material used for the concrete can be stored in a silo, the silo being enrobed in an electrical blanket, to provide for flowability of the granular material in cold conditions.

According to another aspect, the water used for the concrete mixture can be heated in cold conditions.

Advantages, features and characteristics of the present invention will become apparent upon a review of the following detailed description with reference to the accompanying drawings, the latter being briefly described hereinafter.

### BRIEF DESCRIPTION OF THE DRAWINGS

In the Appended Drawings:

FIG. 1 is a view of a prior art mold table;

FIG. 2 is a view of a prior art thumper cart;

FIG. 2.1 is a view of the mold table on top of the thumper cart;

FIG. 3 is a view of a tilt table in a horizontal position;

FIG. 4 is a view of the tilt table of FIG. 3 loaded with a mold and panel;

FIG. 5 is a view of tilt table with an extender in a vertical position, the extender being in receipt of a panel;

FIG. 6 is a view of the comb in receipt of a panel;

FIG. 7 is a view of a panel being lifted from a comb;

FIG. 8 is a view of a crane-supported bucket;

FIG. 9 is a view of a prior art bin

FIG. 10 is a view of a blanket on the bin; and

FIG. 11 is a view showing the equipment loaded for transport.

### DETAILED DESCRIPTION OF AN EMBODIMENT OF THE IMPROVED METHOD

In the example embodiment, the parking structures and the method for construction are of the type described in U.S. Ser. No. 12/870,240, incorporated herein by reference. By way of background, the prior art involves structures, a facility and a method.

The structures are each of the type having: a site; one or more parking decks, each deck being defined by a plurality of horizontal cementitious panels; for and supporting each of said one or more parking decks, a plurality of horizontal steel beams; and columns supporting the beams.

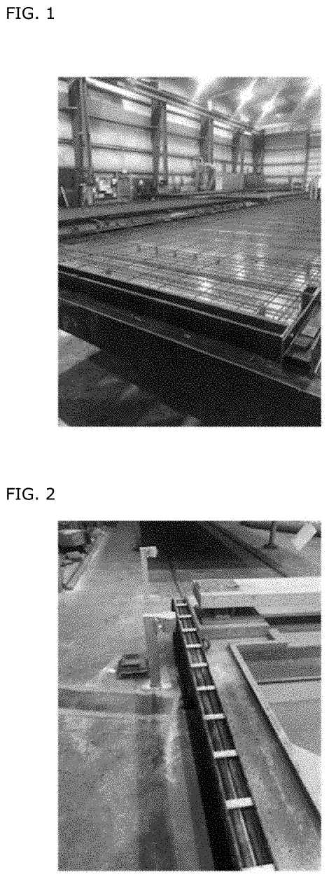

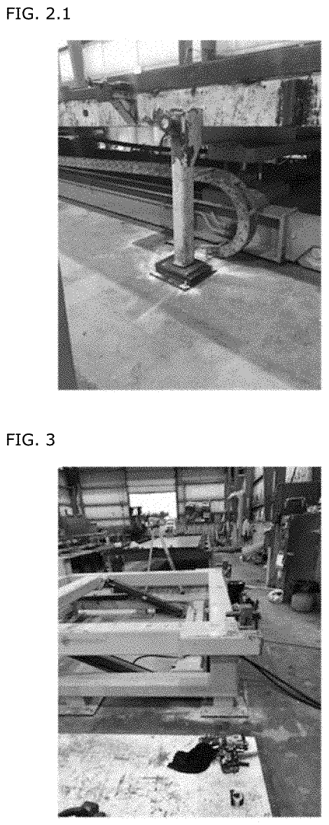

The facility has: a plurality of molds [FIG. 1]; a mixer for producing a supply of fluid concrete; a rail-mounted concrete dispenser/finisher in the form of a gantry adapted to, in use, receive said supply of fluid concrete from the mixer and deliver same to a mold, the gantry including dual vibrating screeds which move between raised and lowered positions, the gantry, in use: (i) filling the mold with said supply of fluid concrete, finishing the concrete in a first pass over the mold with the screeds in the lowered positions; and returns towards the mixer in a second pass over the mold with the screeds in the raised positions; a staging area, in which molds are placed before filling; thumper cart [FIG. 2], upon which the table is loaded [FIG. 2.1] which transports mold tables by rail from the staging area to the molding area for filling and, after the gantry has made its first pass, vibrates the mold to remove voids from the fluid concrete contained therewithin.

The method involves: producing the panels at the facility; installing the columns at the site; fixing cambered beams to the columns and jacking the ends of the beams; moving the panels to the site and placing them upon the cambered beams; grouting the interstices between the panels; and removing the jacks to allow gravity to remove the camber from the beams and the place the grout and the upper surfaces of the panels into compression.

Persons of ordinary skill will readily appreciate that the teachings of U.S. Ser. No. 12/870,240 represented a significant advantage over typical cast in place parking garages. By using principles of modular construction for the garage, and assembly line type manufacture for the modules, garages of relatively low cost and relatively high quality can be constructed within a relatively large area surrounding the manufacturing facility for the panels, basically, that area to which massive cementitious elements can be transported without undue cost. [The beams and columns will typically also be constructed at the facility, but, being substantially lighter, are relatively easily transported; where suitable heavy steel fabrication facilities existed near the construction site, that option would of course be employed.]

The improved method differs from the prior art method in several ways.

### Tilt Table and Comb Used in Panel Production

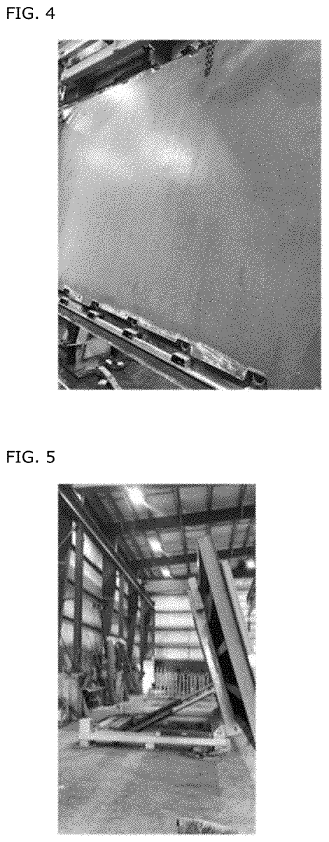

Tilt table [FIG. 3] is adapted to receive a mold table and a panel contained therein and to tilt the mold table and contained panel between a horizontal molding [FIG. 4] position and a vertical release position [FIG. 5].

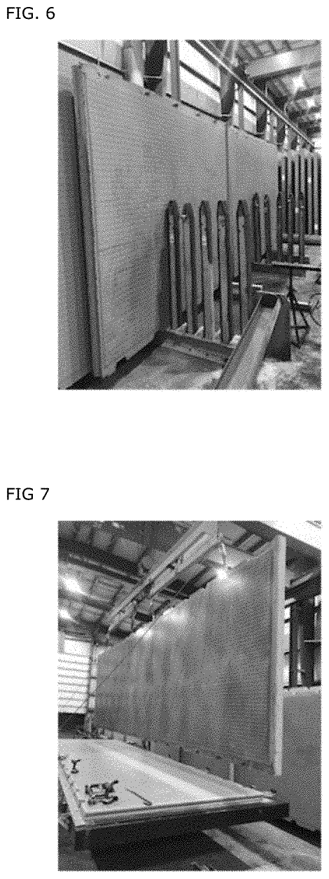

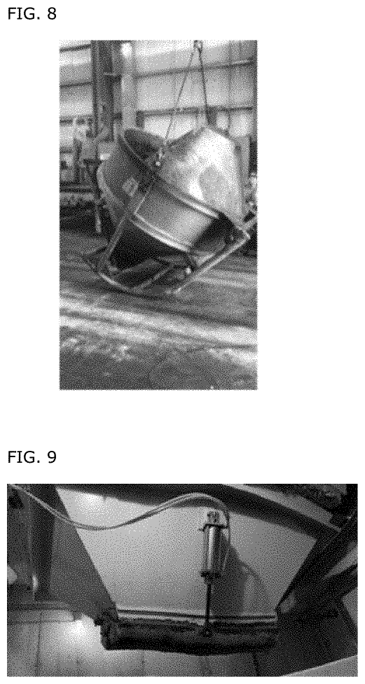

Comb is adapted to support a panel in a vertical position [FIG. 6].

Panel production involves: pouring concrete into a mold table; allow the concrete to harden to form a green panel; tilting the table and the green panel 90° with the tilt table; moving the green panel to the comb with a crane; curing the green panel in the comb to form a panel. When the panel is ready for installation, an extender is added to the tilt table; the panel is lifted by the crane from the comb, placed upon the upright table/extender and pivoted, along with the tilt table, to a horizontal position, to permit subsequent movement in the horizontal position by the crane or another steel carrier to a flatbed for shipment to the site.

### No On-Premises Concrete Mixer and Aggregate Storage

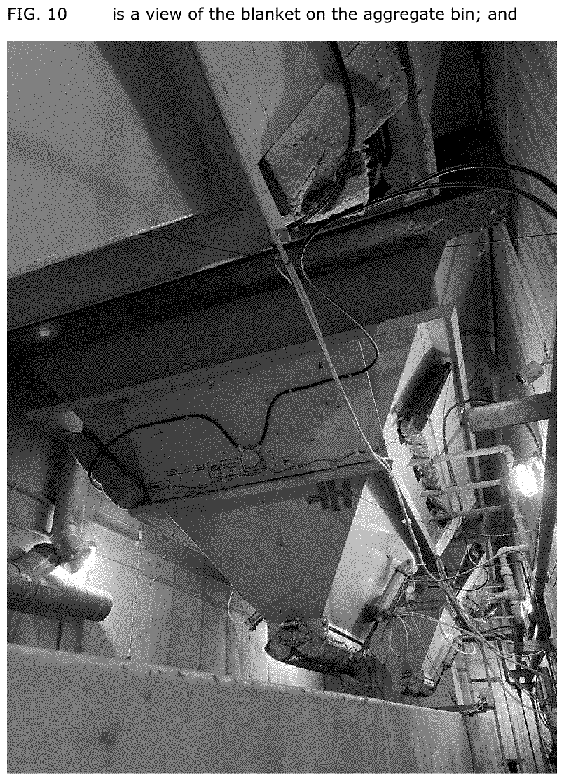

In the improved method, the concrete is: mixed remote from the premises and shipped to the premises in a ready-mix truck; or shipped to the premises in a mixer truck; and delivered to a crane-supported bucket [FIG. 8] at the premises and delivered thereby to the form. In cold weather, the silo that houses the aggregate [FIG. 9] is sheathed with an electrical blanket [FIG. 10] to improve flowability of the granular material and to increase the mix temperature; also to improve mix temperature, hot water is used for the mix.

### Temporary Premises

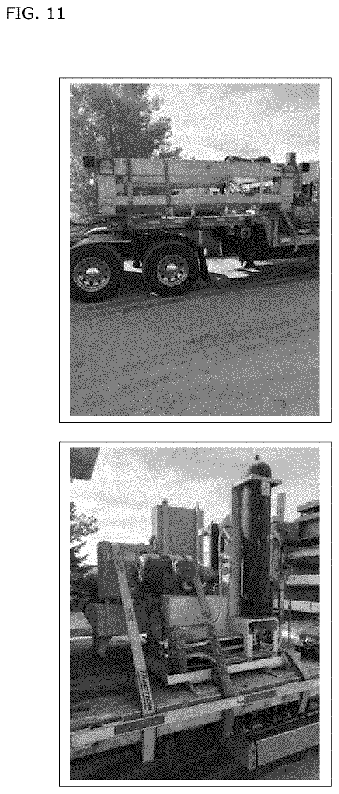

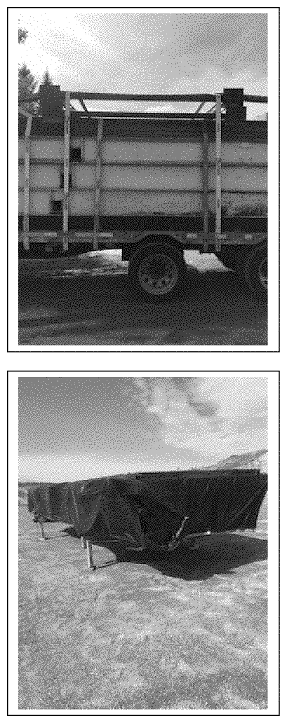

In the present method, the molds, tilt table, extender, thumper table, comb are transported [FIG. 11] to premises near the construction site, as is the electrical blanket, if necessary. Once the panels of a garage in the series have been completed, the equipment is transported to the next garage in the series to be completed, or back to the fixed facility.

1. An improved method for constructing parking structures,
each parking structure having a site and being of the type including a plurality of parking decks, each deck being defined by a plurality of steel beams supporting a plurality of cementitious panels,
the method being of the type wherein each panel is manufactured by pouring concrete into a form remote from the site,
the improvement comprising:
transporting a plurality of forms to premises proximal to the site; and
constructing the panels.

2. The method according to claim 1, wherein the concrete is:
mixed remote from the premises and shipped to the premises in a ready-mix truck; or
shipped to the premises in a mixer truck.

3. The method according to claim 3, wherein the concrete is delivered to a crane-supported bucket at the premises and delivered thereby to the form.

4. The method according to claim 1, wherein the concrete poured into a form is hardened to form a green panel and the green panel is transformed by subsequent curing into a panel.

5. The method according to claim 6, wherein curing of green panels is carried out externally of the forms.

6. The method of claim 5, wherein removal of a green panel from a form involves tilting the form and the green panel 90° by a tilt table.

7. The method according to claim 8, wherein the panels are cured at the premises in a comb.

8. The method according to claim 9, wherein the green panel, once tilted by the tilt table, is moved by a crane to the comb.

9. The method according to claim 8, wherein the comb has been transported to the premises.

10. The method of claim 8, wherein the tilt table has been transported to the premises.

11. The method of claim 1, wherein the parking garages are completed in seriatim and, once the panels of a garage in the series have been completed, the forms and tilt table are transported to the next garage in the series to be completed.

12. The method of claim 1, wherein the granular material used for the concrete is stored in a silo, the silo being enrobed in an electrical blanket, to provide for flowability of the granular material in cold conditions.

13. The method of claim 1, wherein the water used for the concrete mixture is heated in cold conditions.
